(19) United States
(12) Patent Application Publication
(10) Pub. No.: US 2010/0311434 A1
(43) Pub. Date: Dec. 9, 2010

(54) INTERFERENCE MITIGATION IN HYBRID MOBILE RADIO COMMUNICATION NETWORKS

(76) Inventors: Lin Du, Beijing (CN); Dan Shang, Shanghai (CN)

Correspondence Address: Docket Clerk, P.O. Box 802432, Dallas, TX, 75380, US

(21) Appl. No.: 12/733,977

(22) PCT Filed: Sep. 30, 2008
(86) PCT No.: PCT/IB2008/053972

§ 371 Date: Aug. 25, 2010

(30) Foreign Application Priority Data
Sep. 30, 2007 (CN) 200710164218.0

(51) Int. Cl. H04W 72/08

(52) U.S. Cl. 455/452.2

(57) ABSTRACT

In ad hoc enabled cellular systems, the terminals in ad hoc communications (1-16) may generate serious interference to the terminals in conventional communications (C1-C7). The possible interference to be generated from the ad hoc mobile terminals to the conventional terminals is estimated, so that the ad hoc mobile terminals can select the proper radio resource for the sake of interference avoidance. The ad hoc mobile terminals may perform interference estimation in three steps: parameter collection (4-1, 4-2, 4-3), parameter calculation (4-5) and then decision making with the comparison of the calculated result and a predefined threshold (4-6). The whole process is easy to implement and can guarantee quality of conventional communication while maintaining high spectrum efficiency.

In recent years, mobile ad hoc networks have attracted significant attention due to their characteristics, which include a self-organizing structure, adaptiveness, robustness, etc. With the recent development and deployment of 3G mobile communication systems and research on future B3G/LTE systems, the convergence of ad hoc and cellular networks (i.e., terminals in the network can work in both ad hoc and cellular modes) has gained increased interest. A radio communication network in which the characteristics of both an ad hoc network and a cellular network are present may be referred to as a hybrid radio communication network.

To avoid the interference from the ad hoc terminals to the conventional terminals in such a network, the easiest method is to forbid the ad hoc terminals from using the downlink timeslots for communication. However, in multiple access systems, this will damage system efficiency significantly.

For hybrid radio communication networks, the possible interference from the ad hoc mobile terminals to the conventional terminals is estimated so that some ad hoc mobile terminals can still reuse the same downlink timeslots as the conventional terminals when the interference to the conventional terminals is bearable. Consequently, the system efficiency can be greatly improved as a result of the generation of less interference and greater resource reuse.

One method estimates the interference from the ad hoc terminal transmitters to the conventional terminal receivers in an ad hoc enabled cellular system, so that the ad hoc mobile terminals can select the proper radio resource for communication and avoid generating excessive interference to the conventional terminals. One form of the method has the following features:

1. The interference avoidance method is managed by the interference generator itself, i.e., the ad hoc terminal transmitter.
2. The ad hoc terminal measures three parameters for the interference estimation: its received uplink interference, the pathloss from it to the base stations and the received conventional power at the base stations.
3. By comparing a predefined threshold with the calculated results based on the measured parameters, the ad hoc terminal can decide whether it may cause excessive interference to the conventional mobile terminals nearby and decide whether the downlink timeslots can be used for ad hoc communication.

The whole procedure may be performed solely by the ad hoc mobile terminals, and the required parameters can be obtained easily. As a result, the solution is easy to implement and can suppress undesired interference while still keeping high spectrum efficiency.

Other features and advantages will be understood upon reading and understanding the detailed description of exemplary embodiments, found herein below, in conjunction with reference to the drawings, a brief description of which is provided below.

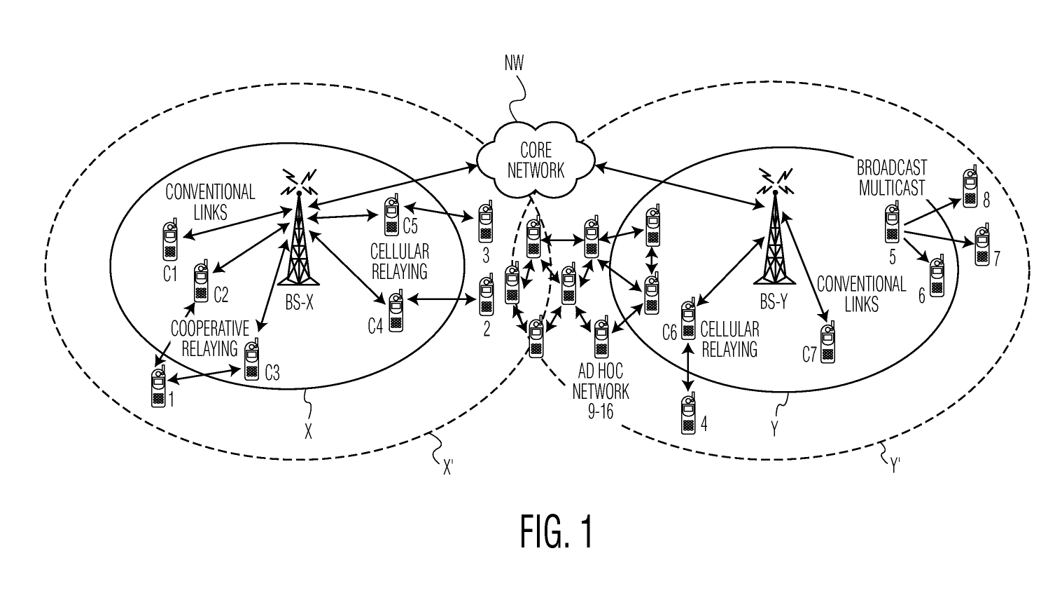

FIG. 1 is a diagram of an ad hoc enabled cellular system;

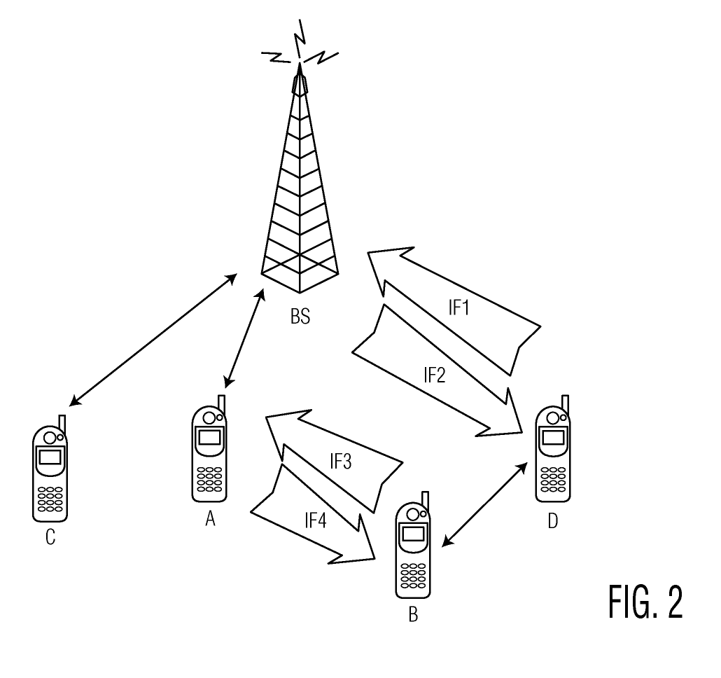

FIG. 2 is a diagram illustrating different kinds of interference in the ad hoc enabled cellular system;

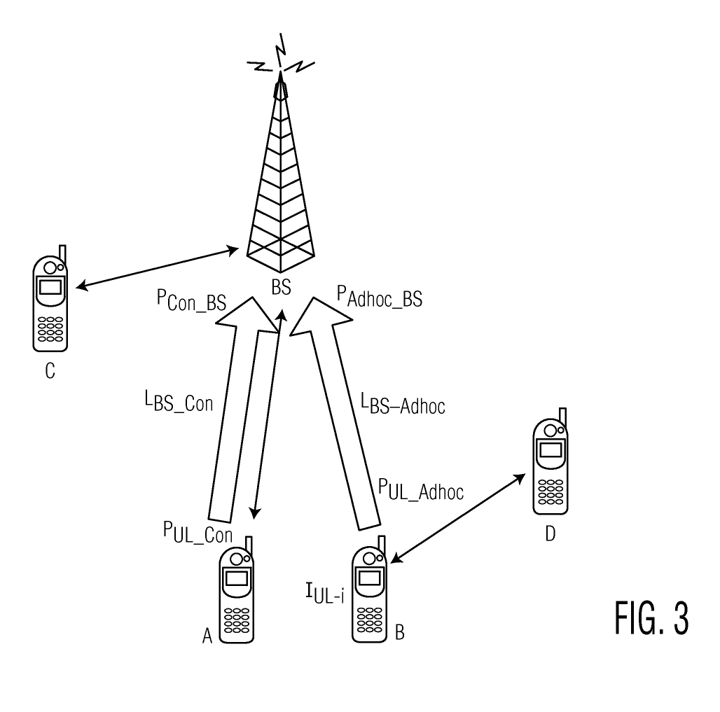

FIG. 3 is a diagram illustrating interference estimation in an ad hoc enabled cellular system;

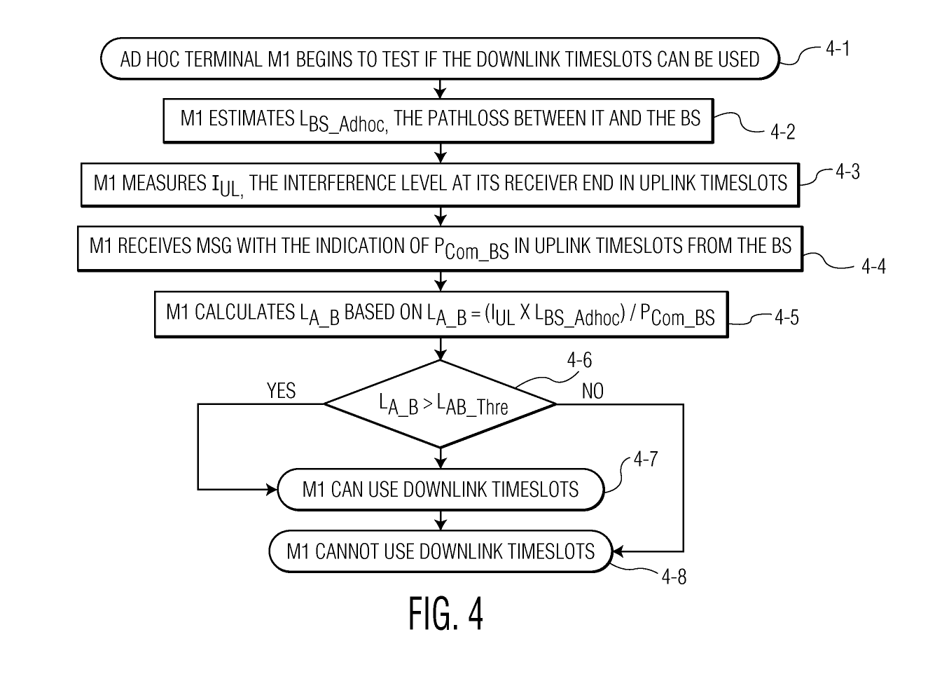

FIG. 4 is a flowchart illustrating an interference avoidance procedure; and

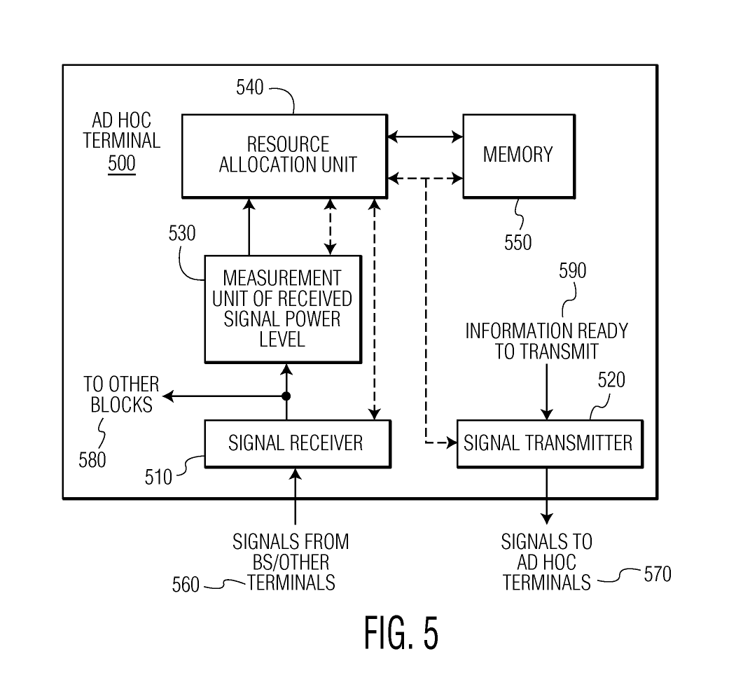

FIG. 5 is a block diagram of an ad hoc terminal capable of performing the interference avoidance procedure.

There follows a more detailed description of the present invention. Those skilled in the art will realize that the following detailed description is illustrative only and is not intended to be in any way limiting. Other embodiments of the present invention will readily suggest themselves to such skilled persons having the benefit of this disclosure. Reference will now be made in detail to embodiments of the present invention as illustrated in the accompanying drawings. The same reference indicators will be used throughout the drawings and the following detailed description to refer to the same or like parts.

FIG. 1 illustrates the integration of an ad hoc network and a cellular system. The mobile cellular network infrastructure is used as the physical layer of the ad hoc network instead of the conventional wireless LAN. In this integrated system, the mobile end users can still communicate with each other via the traditional cellular network. In addition, the mobile end users can also communicate with each other directly without the base station relay, no matter whether they are in the coverage area of the base station or not. The mobile terminals can form a network themselves or can request help from mobile terminals able to connect to the base station. In the ad hoc enabled cellular system, the mobile terminals that have data traffic links with the base station are termed conventional mobile terminals, and the mobile terminals that have data traffic links directly with other mobile terminals are termed ad hoc mobile terminals. In the example of FIG. 1, a network cell X is served by a base station BS-X, and a network cell Y is served by a base station BS-Y. Base stations BS-X and BS-Y are served by a core network NW. In cell X, terminals C1-C5 are conventional mobile terminals that have conventional links with the base station BS-X. Terminals 1-3 are ad hoc mobile terminals, located in a fringe area X′ beyond the range of the base station BS-X. In the illustrated example, ad hoc mobile terminals 2 and 3 communicate with the base station BS-X through respective conventional mobile terminals 4 and 5 using cellular relaying. Ad hoc mobile terminal 1 communicates with the base station BS-X through both conventional mobile terminal C2 and conventional mobile terminal C3 using cooperative relaying. Both relaying techniques are known in the art.

In cell Y, terminals C6 and C7 are conventional mobile terminals that have conventional links with the base station Y. The remaining terminals 5-8 are ad hoc mobile terminals, including in a fringe area Y′ beyond the range of the base station BS-Y ad hoc mobile terminals 4, 7 and 8. Ad hoc mobile terminal 4 communicates with the base station BS-Y through conventional mobile terminal C6 using cellular relaying. In this example, ad hoc mobile terminal 5 carries out broadcast multicast communication with ad hoc mobile terminals 6-8.

In an area including portions of fringe areas X′ and Y′ and a portion of cell Y, an ad hoc network is formed by ad hoc mobile terminals 9-16, which communicate amongst themselves using cellular frequencies.

Referring to FIG. 2, a simplified model of an ad hoc enabled cellular system is shown. A base station BS communicates with conventional mobile terminals A and C. Ad hoc mobile terminals B and D communicate with one another. As illustrated in FIG. 2, there are four kinds of interference in the ad hoc enabled cellular system:

1. Interference IF1 from the ad hoc terminal transmitters to the base station receivers;
2. Interference IF2 from the base station transmitters to the ad hoc terminal receivers;
3. Interference IF3 from the ad hoc terminal transmitters to the conventional terminal receivers; and
4. Interference IF4 from the conventional terminal transmitters to the ad hoc terminal receivers.

The first two kinds of interference are easy to manage because the distances between the ad hoc terminals and the base stations are usually long enough to make the interference between them negligible. However, the last two kinds of interference should be carefully treated because the ad hoc terminals and conventional terminals may be very close to each other and therefore can cause serious interference.

For the interference from the conventional terminal transmitters to the ad hoc terminal receivers, the ad hoc terminal receivers can try to avoid it by dynamically adjusting to the radio resource with the least interference.

For the interference from the ad hoc terminal transmitters to the conventional terminals receivers, the solution is more difficult. In ad hoc enabled TDD cellular networks, severe interference from the ad hoc terminal transmitters to the conventional terminal receivers is generated by ad hoc terminals that use the conventional downlink timeslots for communication. Ad hoc terminals that use only the uplink timeslots for communication will not interfere with the conventional mobile terminals, because the conventional mobile terminals do not receive data in the uplink timeslots. As a result, it should be carefully decided whether the downlink timeslots can be allocated to the ad hoc terminals. The base station does not have any information about the interference among the conventional mobile terminals, so it can do nothing about this interference problem. In addition, the conventional terminals should not be changed because most of them will have already been sold before the addition of the ad hoc feature to the cellular system. As a result, the interference from the ad hoc terminal transmitters to the conventional terminal receivers can only be managed by the ad hoc terminals.

The pathloss between two mobile terminals has an effect on the interference between them. For the same transmission power, the lower the pathloss, the more the interference generated from one to the other. Therefore, the possible interference from the ad hoc mobile terminals to the conventional mobile terminals can be estimated by estimating the pathloss between them. Referring to FIG. 3, a simplified model of an ad hoc enabled cellular system like that of FIG. 2 is shown. A base station BS communicates with conventional mobile terminals A and C. Ad hoc mobile terminals B and D communicate with one another. As illustrated in FIG. 3, the interference between A and B can be figured out if the pathloss between them—L_{A}_{_{—}}_{B}, can be deduced. The deduction of L_{A}_{_{—}}_{B} may be accomplished as follows:

1. If P_{UL}_{_{—}}_{Con} is the uplink transmission power of conventional terminal A and I_{UL} is the interference at the ad hoc terminal B in the uplink radio resource, then

L_{A}_{_{—}}_{B}=I_{UL}/P_{UL}_{_{—}}_{Con} (Equation 1).

2. If P_{Con}_{_{—}}_{BS} is the received power of terminal A at the base station and L_{BS}_{_{—}}_{Con} is the pathloss between A and the base station, then

P_{UL}_{_{—}}_{Con}=P_{Con}_{_{—}}_{BS}/L_{BS}_{_{—}}_{Con} (Equation 2).

3. Replacing P_{UL}_{_{—}}_{Con} with Equation 2,

L_{A}_{_{—}}_{B}=(I_{UL}×L_{BS}/P_{Con}_{_{—}}_{BS}) (Equation 3).

4. L_{BS}_{_{—}}_{Adhoc} is the pathloss between B and the base station. When A is quite close to B, it may be assumed that L_{BS}_{_{—}}_{Con}≈L_{BS}_{_{—}}_{Adhoc}. So Equation 3 can be rewritten as

L_{A}_{_{—}}_{B}=(I_{UL}×L_{BS}_{_{—}}_{Adhoc})/P_{Con}_{_{—}}_{BS} (Equation 4)

Based on Equation 4, the ad hoc mobile terminals can estimate the pathloss between them and the conventional terminals in the uplink timeslots by having three parameters—I_{UL}BS_{_{—}}_{Adhoc} and P_{Con}_{_{—}}_{BS}. For I_{UL}, the ad hoc terminal can measure it directly with its receiver at any time. The ad hoc terminals simply tune to the uplink radio resource and take an RSSI reading of the received signal strength in the uplink timeslots. For L_{BS}_{_{—}}_{Adhoc}, the ad hoc terminal can estimate it by periodically overhearing the downlink pilot signal, which is transmitted with a fixed, known power. For P_{Con}_{_{—}}_{BS}, the ad hoc terminal can get it in two ways. One is to have this parameter sent by the base station in real time; another is to estimate this parameter based on P_{Adhoc}_{_{—}}_{BS}, which is the received power of the ad hoc terminal at the base station during an access procedure.

More particularly, in the ad hoc enabled cellular network, if the ad hoc terminals are within base station coverage, they may follow the same or similar access procedure as the conventional terminal before setting up communication links. During the access procedure, the base station can determine the power P_{Adhoc}_{_{—}}_{BS} of the access signal transmitted by the mobile terminal and the base station can notify the mobile terminal of the received power. P_{Adhoc}_{_{—}}_{BS}_{_{—}}_{Con} is the data signal strength received by the base station if the ad hoc terminal sends data to the base station. In general, the ratio R_{access/data} between the access signal strength P_{Adhoc}_{_{—}}_{BS} and the data signal strength P_{Adhoc}_{_{—}}_{BS}_{_{—}}_{Con} is a value that can be determined in the field, this value depending on user density, the cell radius, etc. Therefore, based on P_{Adhoc}_{_{—}}_{BS} and R_{access/data}, the mobile terminal can estimate the data signal strength P_{Adhoc}_{_{—}}_{BS}_{_{—}}_{Con}. In a steady system, P_{Con}_{_{—}}_{BS} is almost equal to P_{Adhoc}_{_{—}}_{BS}_{_{—}}_{Con}. That is, P_{Con}_{_{—}}_{BS} can be replaced with P_{Adhoc}_{_{—}}_{BS} with reasonable accuracy, when the base station traffic load does not vary significantly after its first measurement. If the traffic load of the system varies too much, the estimated power is not accurate, and the correct solution is not known. However, estimation of P_{Con}_{_{—}}_{BS} is done during the resource allocation procedure, when the ad hoc terminal first accesses the system. Therefore, the probability is low that the network load will vary too much in the period between the access procedure and the resource allocation procedure.

The foregoing concerns the estimation of the pathloss from one conventional terminal to one ad hoc terminal. For the estimation of the interference from multiple conventional terminals to one ad hoc terminal, the same method based on Equation 4 can still be used to estimate the pathloss by assuming that multiple conventional terminals are mapped into one position. This assumption is reasonable, as the variation of the additive interference is much smaller than that of the pathloss. For the case of multiple conventional terminals, P_{Con}_{_{—}}_{BS} is the received power of multiple terminals at the base station.

Referring to FIG. 4, a detailed procedure for interference avoidance based on Equation 4 includes the following steps:

1. Ad hoc mobile terminal M1 begins to test if the downlink timeslots are usable.
2. M1 periodically receives the downlink pilot signal sent by the base station. As the transmission power of the pilot signal is fixed, M1 can estimate the pathloss L_{BS}_{_{—}}_{Adhoc} between the base station and it based on the received pilot signal.
3. M1 periodically measures the interference level I_{UL} at M1's receiver end in uplink timeslots.
4. M1 receives a message with the indication of P_{Con}_{_{—}}_{BS} in uplink timeslots from the base station (or estimates P_{Con}_{_{—}}_{BS} based on P_{Adhoc}_{_{—}}_{BS} during its random access procedure to the base station).
5. M1 calculates L_{A}_{_{—}}_{B} based on Equation 4 (L_{A}_{_{—}}_{B}=(I_{UL}×L_{BS}_{_{—}}_{Adhoc})/P_{Con}_{_{—}}_{BS}) with the three parameters obtained in the above three steps.
6. M1 compares L_{A}_{_{—}}_{B} with a predefined threshold L_{AB}_{_{—}}_{Thre}. If L_{A}_{_{—}}_{B}>L_{AB}_{_{—}}_{Threshold}, M1 can use the downlink timeslots, otherwise it cannot. L_{AB}_{_{—}}_{Threshold} is a predefined parameter in considerations of the system load, the pathloss model, the power ratio between signaling and data links, etc.
7. If permitted, M1 can continue the ad hoc communication by using radio resources in the downlink timeslots; otherwise M1 can only use uplink timeslots to set up/maintain the ad hoc communication.

The steps of the method of FIG. 4 are summarized in the following table:

| Step | Description |
|---|---|
| 4-1 | Ad hoc terminal M1 begins to test if the downlink |
| | timeslots can be used |
| 4-2 | M1 estimates L_{BS}_{_{—}}_{Adhoc}, the pathloss between it and the BS |
| 4-3 | M1 measures I_{UL}, the interference level at its receiver |
| | end in uplink timeslots |
| 4-4 | M1 receives message with the indication of P_{Con}_{_{—}}_{BS} in |
| | uplink timeslots from the BS |
| 4-5 | M1 calculates LA_B based on L_{A}_{_{—}}_{B} = (I_{UL} × L_{BS}_{_{—}}_{Adhoc})/ |
| | P_{Con}_{_{—}}_{BS} |
| 4-6 | Test whether L_{A}_{_{—}}_{B} > L_{AB}_{_{—}}_{Thre} |
| 4-7 | If yes, M1 can use downlink timeslots |
| 4-8 | If no, M1 cannot use downlink timeslots |

Referring to FIG. 5, a simplified block diagram is shown of an ad hoc terminal 500 capable of performing the interference avoidance procedure of FIG. 4. The ad hoc terminal includes a signal receiver 510, a signal transmitter 520, a measurement unit 530, a resource allocation unit 540 and memory 550. The resource allocation unit 540 may be realized in hardware or realized in the form of software running on a processor that performs multiple functions. The principal flow of information between blocks is indicated by solid lines, while the exchange of control signals is indicated by dashed lines. The resource allocation unit 540 is connected to the signal receiver 510, the measurement unit 530, the signal transmitter 520 and memory 550 and exchanges control signals with the same as necessary. Signals from base stations and other terminals (indicated by reference numeral 560) are received by the signal receiver 510 and applied to the measurement unit 530 and to other blocks of the ad hoc terminal (indicated by reference numeral 580). Information ready to be transmitted by the ad hoc terminal 500 (indicated by reference numeral 590) is applied to the signal transmitter 520 and transmitted as signals to other ad hoc terminals (indicated by reference numeral 570), under control of the resource allocation unit 540.

The three pieces of information needed by the resource allocation unit to perform the interference avoidance procedure of FIG. 4 may, for example, be obtained as follows.

To obtain I_{UL}, the resource allocation unit causes the signal receiver 510 to be tuned to the targeted radio resource. The measurement unit 530 measures the received power signal level, which is read by the resource allocation unit 540. To obtain L_{BS}_{_{—}}_{Adhoc}, the resource allocation unit causes the signal receiver 510 to be tuned to receive a pilot signal from the base station. The measurement unit 530 measures the received power signal level, which is read by the resource allocation unit 540. Knowing the transmitted power signal level of the pilot signal, the resource allocation unit 540 can then calculate L_{BS}_{_{—}}_{Adhoc}. In the illustrated embodiment, to obtain P_{Con}_{_{—}}_{BS}, the resource allocation unit 540 retrieves the latest stored value from memory 550, with the value being updated in real time by transmissions from the base station.

Using the foregoing information, the resource allocation unit 540 calculates L_{A}_{_{—}}_{B} and compares it to a threshold value. If the comparison is favorable, then the resource allocation unit 540 considers the resource to be available for use and commands the signal transmitter 520 to use the radio resource to proceed with transmission of information ready to transmit.

Although embodiments of the present invention have been described in detail, it should be understood that various changes, substitutions and alternations can be made without departing from the spirit and scope of the inventions as defined by the appended claims.

1. A method of mitigating interference between a plurality of mobile terminals including at least a first mobile terminal and a second mobile terminal wherein the second mobile terminal uses a radio resource to communicate with a base station and the first mobile terminal evaluates the same radio resource for use to communicate with a terminal or station other than the base station if interference conditions allow, the method comprising the steps of the first mobile station:
estimating a pathloss of the radio resource between the first mobile terminal and the second mobile terminal;
comparing the estimated pathloss with a threshold;
if the estimated pathloss is greater than the threshold, the first mobile station allowing itself to use the radio resource; and
if the estimated pathloss is less than the threshold, the first mobile station not allowing itself to use the radio resource.

2. The method of claim 1, wherein estimating the pathloss of the radio resource between the first mobile terminal and the second mobile terminal comprises estimating pathloss of the radio resource between the first mobile terminal and the base station.

3. The method of claim 1, wherein estimating the pathloss of the radio resource between the first mobile terminal and the second mobile terminal comprises measuring the interference level of the radio resource at the first mobile terminal due to transmission by the second mobile terminal.

4. The method of claim 1, wherein estimating the pathloss of the radio resource between the first mobile terminal and the second mobile terminal comprises obtaining information concerning the power level of the second mobile terminal at the base station.

5. The method of claim 4, wherein obtaining information concerning the power level of the second mobile terminal at the base station comprises receiving measurement information from the base station.

6. The method of claim 4, wherein obtaining information concerning the power level of the second mobile terminal at the base station comprises:
the first mobile terminal accessing the base station;
determining the power level of the first mobile terminal at the base station; and
estimating the power level of the second mobile terminal at the base station in relation to the power level of the first mobile terminal at the base station.

7. The method of claim 1, wherein estimating the pathloss of the radio resource between the first mobile terminal and the second mobile terminal comprises:
estimating pathloss of the radio resource between the first mobile terminal and the base station;
measuring the interference level of the radio resource at the first mobile terminal due to transmission by the second mobile terminal; and
obtaining information concerning the power level of the second mobile terminal at the base station.

8. The method of claim 7, comprising estimating the pathloss of the radio resource between the first mobile terminal and the second mobile terminal as the product of i) the estimated pathloss of the radio resource between the first mobile terminal and the base station and ii) the interference level of the radio resource at the first mobile terminal, divided by iii) the power level of the second mobile terminal at the base station.

9. A first mobile terminal that mitigates interference between itself and a second mobile terminal wherein the second mobile terminal uses a radio resource to communicate with a base station and the first mobile terminal evaluates the same radio resource for use to communicate with a terminal or station other than the base station if interference conditions allow, the first mobile terminal comprising:
a receiver;
a signal measurement unit coupled to the receiver for performing signal measurements with respect to the radio resource; and
a resource allocation unit coupled to the signal measurement unit for receiving measurements from the signal measurement unit, determining an estimated pathloss of the radio resource between the first mobile terminal and the second mobile terminal, and comparing the estimated pathloss to a threshold;
wherein the resource allocation unit allows the first mobile station to use the radio resource if the estimated pathloss is greater than the threshold, and does not allow the first mobile station to use the radio resource if the estimated pathloss is less than the threshold.

10. The apparatus of claim 9, wherein the signal measurements comprise received signal power level of the radio resource due to transmission by the second mobile terminal.

11. The apparatus of claim 9, wherein the signal measurements comprise received signal power level of a pilot signal.

12. The apparatus of claim 9, wherein the signal measurements comprise a received signal power level of the radio resource due to transmission by the second mobile terminal, and received signal power level of a pilot signal.

13. The apparatus of claim 12, comprising a memory for storing a received power level at the base station of transmissions by the second mobile terminal using the radio resource.

14. The apparatus of claim 13, wherein the estimated pathloss is determined as the product of i) an estimated pathloss of the radio resource between the first mobile terminal and the base station and ii) the received signal power level of the radio resource due to transmission by the second mobile terminal, divided by iii) the received power level at the base station of transmissions by the second mobile terminal using the radio resource.

15. A method of operating a radio communications network to facilitate interference mitigation, the radio communications network comprising a base station, a first mobile terminal and a second mobile terminal, wherein the second mobile terminal uses a radio resource to communicate with a base station and the first mobile terminal evaluates the same radio resource for use to communicate with a terminal or station other than the base station if interference conditions allow, the method comprising:
the base station transmitting information concerning the power level of the second mobile terminal at the base station;
receiving at the first mobile terminal the information concerning the power level of the second mobile terminal at the base station; and
the first mobile terminal using the information concerning the power level of the second mobile terminal at the base station to make a decision whether to reuse a radio resource used by the second mobile station.

16. The method of claim 15, wherein the information comprises signal power level of the radio resource due to transmission by the second mobile terminal.

17. The method of claim 15, wherein the information comprises received signal power level of a pilot signal.

18. The method of claim 15, wherein the information comprise a received signal power level of the radio resource due to transmission by the second mobile terminal and received signal power level of a pilot signal.

19. The method of claim 15, wherein the first mobile station comprises a memory for storing a received power level at the base station of transmissions by the second mobile terminal using the radio resource.

20. The method of claim 19, wherein the information comprise a received signal power level of the radio resource due to transmission by the second mobile terminal and received signal power level of a pilot signal.
